(19) United States
(12) Patent Application Publication
(10) Pub. No.: US 2013/0232267 A1
(43) Pub. Date: Sep. 5, 2013

(54) SYSTEM AND METHOD FOR RESOURCE-BASED NETWORK POLICY CONTROL IN A NETWORK ENVIRONMENT

(71) Applicants: Kevin D. Shatzkamer, Hingham, MA (US); Eric Hamel, Paris (FR); Mark Grayson, Maidenhead (GB)

(72) Inventors: Kevin D. Shatzkamer, Hingham, MA (US); Eric Hamel, Paris (FR); Mark Grayson, Maidenhead (GB)

(73) Assignee: Cisco Technology, Inc.

(21) Appl. No.: 13/409,463

(22) Filed: Mar. 1, 2012

(51) Int. Cl. G06F 15/173

(52) U.S. Cl. 709/226

(57) ABSTRACT

A method is provided in one example embodiment that includes aggregating resource availability from a plurality of network elements operating in a network; receiving a request to apply a policy to a network flow propagating in the network; and orchestrating resources to apply the policy to the network flow based on the aggregated resource availability. In more particular embodiments, the policy includes a quality of service for the network flow. In addition, the policy can include relocating subscribers accessing common content from a first gateway to a second gateway. In other instances, the policy includes relocating resources for the network flow.

### TECHNICAL FIELD

This specification relates in general to the field of communications, and more particularly, to a system and a method for resource-based network policy control in a network environment.

### BACKGROUND

Networking architectures have grown increasingly complex in communications environments, particularly mobile wireless environments. Mobile data traffic has grown extensively in recent years, which has significantly increased the demands on all resources. As the subscriber base of end users increases, efficient management of communication resources becomes even more critical. Network functions for managing traffic can overload elements of wireless networks, and can even cause service disruptions. Hence, there is a significant challenge in managing network resources as the subscriber base continues to increase.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating an example embodiment of a communication system in accordance with this specification;

FIG. 2 is a simplified block diagram illustrating additional details that may be associated with an example embodiment of a data center in the communication system;

FIG. 3 is a simplified block diagram illustrating a hierarchical perspective of an example embodiment of the communication system;

FIG. 4 is a simplified flow diagram illustrating an integration of policy and orchestration services in a unified management domain that may be associated with example embodiments of the communication system; and

FIG. 5 is a simplified flow diagram illustrating potential operations that may be associated with example embodiments of the communication system.

### DETAILED DESCRIPTION OF EXAMPLE EMBODIMENTS

### Overview

A method is provided in one example embodiment and includes aggregating resource availability from a plurality of network elements operating in a network. The term ‘resource availability’ can include any characteristic, description, identifier, level, reporting, etc. associated with finite resources in the network (e.g., bandwidth, billing, quality of service, access parameters, etc.). Additionally, the term ‘aggregating’ in such a context is meant to include any activities associated with receiving, collecting, auditing, soliciting, combining, totaling, gathering, etc. information associated with the resource availability.

The method can also include receiving a request to apply a policy to a network flow propagating in the network, and orchestrating resources to apply the policy to the network flow based on the aggregated resource availability. In this context, the broad term ‘orchestrating’ is inclusive of any activities associated with managing, designing, allocating, delineating, overseeing, defining, or otherwise controlling resources of the network. In more particular embodiments, the policy can include a quality of service for the network flow. In addition, the policy can include relocating subscribers accessing common content from a first gateway to a second gateway. In other instances, the policy includes relocating resources for the network flow.

In certain implementations, aggregating resource availability can include receiving feedback from the plurality of network elements. Additionally, the method can include receiving analytics information indicating that assigned network resources are no longer available for a particular flow. The request can be received from a policy and charging rules function. The orchestration of resources can include designating a path for the network flow. Certain methodologies can include activities associated with determining additional resources are unavailable for a particular network flow propagating in the network; and communicating a response to a particular one of the network elements to indicate that the additional resources are unavailable.

### Example Embodiments

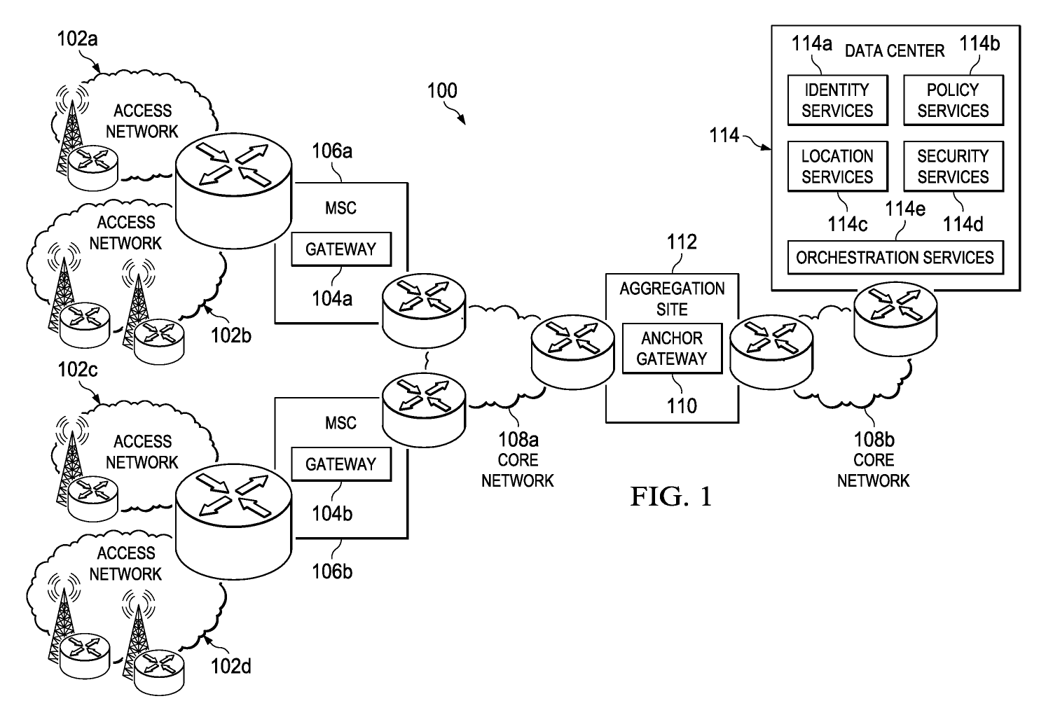

Turning to FIG. 1, FIG. 1 is a simplified block diagram of an example embodiment of a communication system 100 for providing resource-based network policy control in a mobile wireless network environment. Communication system 100 may encompass many subscribers that are distributed across many ingress points connecting to interconnected paths and service destinations. The example architecture of FIG. 1 includes a plurality of access networks 102a-102d. In one particular embodiment, access networks 102a-102d may be representative of radio access networks such as a 3rd Generation Partnership Project (3GPP) or 3GPP2 access network, Wi-Fi, Femto, and/or WiMAX, for example. Radio access technologies may include a 1xRTT transceiver, a high-rate packet data (HRPD) transceiver, an evolved high-rate packet data (eHRPD) transceiver, or a Long Term Evolution (LTE) transceiver, for example.

Access networks 102a-102d can communicate via a dedicated access transport network with a plurality of access gateways 104a-104b, which may be associated with a plurality of mobile switching centers (MSCs) 106a-106b. Such a network configuration can offer a combination of functionalities such as a packet data serving node (PDSN), a serving general packet radio service (GPRS) support node (SGSN), or a serving gateway (SGW), for example. Access gateways 104a-104b can communicate through a core network 108a with an anchor gateway 110, which may be associated with an aggregation site 112. Anchor gateway 110 can provide a common point of attachment as user equipment (not shown) moves between access networks 102a-102d. Anchor gateway 110 may be representative of an HRPD serving gateway (HSGW), a gateway GPRS support node (GGSN), a home agent (HA), or a packet data network gateway (PGW), for example. Anchor gateway 110 can also communicate with a data center 114 through core network 108b. Data center 114 can host a variety of network services, including an instance of identity services 114a, policy services 114b, location services 114c, security services 114d, and orchestration services 114e.

Each of the elements of FIG. 1 may couple to one another through simple interfaces or through any other suitable connection (wired or wireless), which provides a viable pathway for network communications. Additionally, any one or more of these elements may be combined or removed from the architecture based on particular configuration needs. Communication system 100 may include a configuration capable of transmission control protocol/Internet protocol (TCP/IP) communications for the transmission or reception of packets in a network flow. Communication system 100 may also operate in conjunction with a user datagram protocol/IP (UDP/IP) or any other suitable protocol where appropriate and based on particular needs.

User equipment (not shown in FIG. 1) can be associated with clients or customers wishing to initiate a flow in communication system 100 via some network (i.e., an access network). The terms “user equipment,” “mobile node,” “end user,” and “subscriber” are inclusive of devices used to initiate a communication, such as a computer, a personal digital assistant (PDA), a laptop or electronic notebook, a cellular telephone, an iPhone, iPad, a Google Droid phone, any smartphone, an IP phone, or any other device, component, element, or object capable of initiating voice, audio, video, media, or data exchanges within communication system 100. User equipment may also be inclusive of a suitable interface to a user such as a microphone, a display, a keyboard, or other terminal equipment.

User equipment may also be any device that seeks to initiate a communication on behalf of another entity or element such as a program, a database, or any other component, device, element, or object capable of initiating an exchange within communication system 100. Data, as used herein in this document, refers to any type of numeric, voice, video, media, or script data, or any type of source or object code, or any other suitable information in any appropriate format that may be communicated from one point to another. In certain embodiments, user equipment may have a bundled subscription for network access and application services (e.g., voice), etc. Once the access session is established, the user can register for application services as well, without additional authentication requirements. There can be different user data repositories: there may be one for the access user profile and one for the application user profile, for example. IP addresses can be assigned using dynamic host configuration protocol (DHCP), Stateless Address Auto-configuration, default bearer activation, etc., or any suitable variation thereof.

For purposes of illustrating certain example embodiments of communication system 100, it is important to understand certain activities and communications occurring within such a system. Contextual information is provided below to offer an overview of some challenges of managing network resources in a mobile wireless environment. Such information is offered earnestly and for teaching purposes only and, therefore, should not be construed in any way to limit the broad applications of the present disclosure.

Mobile policy control system and infrastructure typically relies on an assignment of resources including Quality of Service (QoS), charging, security, and other inline services based on subscriber, service, or network-layer information. Such rules may be based on a guaranteed bitrate for voice or video, for example, which can translate into a specific deep packet inspection (DPI) function in a mobile gateway, IP differentiated service code point (DSCP) marking, and an appropriate radio access network QoS class. However, these rules generally do not consider how the implementation of policy may impact the underlying physical resources.

Some mobile networks may provide virtualized infrastructure such as software defined radios in which remote radio heads and baseband cards are multi-modal, access gateways that are converged to allow 3G/4G interworking, etc. Mobile backhaul networks may also be converged for transport, including circuit emulation techniques to support legacy time-division multiplexing (TDM) services and clocking-over-packet techniques to support frequency/phase synchronization, for example. In a virtualized environment, functions that require significant resource utilization (such as DPI and encryption services) typically need careful dimensioning, especially when such functions reside within critical network elements, such as a mobile gateway.

In accordance with embodiments disclosed herein, communication system 100 can substantially improve the efficiency of network infrastructure by applying resource orchestration techniques to a policy control subsystem. Applying resource orchestration techniques to a policy control subsystem can provide a robust policy enforcement framework that can account for subscriber and service requirements, resource availability, and network capabilities in a holistic manner.

For example, a policy control subsystem can provide resources that align to a superior (e.g., optimal) path between client and server, within the scope of resource availability: allowing policies to be deployed and enforced for available resources in a cloud environment without regard to physical resource location. A policy control subsystem may also present an aggregated view of resources to business process or applications: enabling these systems to make decisions based on resource availability, without regard to physical resource location. Thus, a policy control subsystem can provide an abstraction layer between network infrastructure and business processes or applications. A policy/orchestration aware entity may further provide logic and analytics to determine that modification of particular IP flows, such as re-attachment, teardown, or QoS modification, can optimize aggregate resource consumption. For example, sessions may be moved to offload a data center, video content may be consolidated to allow multicast transport, or resources can be reconfigured and policies changed because of Layer 1 point of attachment changes.

In more particular embodiments, communication system 100 may provide an abstraction layer, an orchestration layer, and a presentation layer in the control plane to implement resource-based policy control. In general terms, an abstraction layer can overlay network and data center infrastructure to provide an abstracted view of available resources and capabilities. An orchestration layer can receive policy-based scheduling requests for resources from various systems, determine conflicts, prioritize requests, and determine resource availability based on analytics and polling. The orchestration layer may provide a bus communications channel between attached systems. A presentation layer may be operable to aggregate and present an abstracted state of resources, functions, capabilities, etc. to upper layer systems to simplify creation of monetization use cases, and may further provide an interface to exploitable capabilities, such as an application programming interface.

In some embodiments, a presentation layer may also offer resources and tools for the creation of monetization use cases. For example, an end-user system within a Telco environment may request resources, such as DPI, billing record generation, location integration, and network policy control. A presentation layer can communicate the request across an orchestration layer, which can dissect the request into actionable objects for attached systems. In additional, or in alternative embodiments, a presentation layer may provide resources and tools for enabling business-to-business-to-consumer integration. An end-user system within a third-party environment may request specific treatment of services within a partner network without the complexity of integration into numerous Telco systems.

In yet other additional or alternative embodiments, an abstraction layer may receive analytics information indicating assigned network resources are no longer available for delivery of a particular use case. The abstraction layer can notify an orchestration layer, which can process the notification and re-assign resources if other resources are available to enable the use case. If the orchestration layer determines that no other resources are available, the orchestration layer can send appropriate response messages to attached systems. These response mechanisms may also be used for auditing purposes.

In one example implementation, access gateways 104a-104b, anchor gateway 110, and other components of communication system 100 may be implemented in or as network elements, which are meant to encompass network appliances, servers, routers, switches, gateways, bridges, load balancers, firewalls, processors, modules, or any other suitable device, component, element, or object operable to exchange information in a network environment. Moreover, the network elements may include any suitable hardware, software, components, modules, interfaces, or objects that facilitate the operations thereof. This may be inclusive of appropriate algorithms and communication protocols that allow for the effective exchange of data or information. Resources across all such network elements may be combined and orchestrated as described herein to provide aggregate resource availability.

Certain embodiments of communication system 100 may be associated with the 3GPP Evolved Packet System (EPS) architecture, also sometimes referred to as the Long-Term Evolution (LTE) EPS architecture. In general terms, 3GPP defines EPS as specified in TS 23.401, TS.23.402, TS 23.203, etc. The EPS generally consists of IP access networks and an Evolved Packet Core (EPC). The EPC generally comprises a mobility management entity (MME), an SGW, a PGW, and a Policy and Charging Rules Function (PCRF). Access networks 102a-102d may be 3GPP access networks, such a GERAN, UTRAN, and E-UTRAN, or they may be non-3GPP IP access networks such as digital subscriber line (DSL), Cable, WiMAX, code division multiple access (CDMA) 2000, WiFi, or the Internet.

Radio access networks in an LTE architecture can consist of evolved NodeBs (eNodeBs). An eNodeB is generally connected via an access transport network to an EPC, as well as to adjacent eNodeBs. An eNodeB may also be responsible for selecting an MME for user equipment and managing radio resources.

Non-3GPP IP access networks can be divided generally into trusted and untrusted segments. Trusted IP access networks support mobility, policy, and authentication, authorization, and accounting (AAA) interfaces to the EPC, whereas untrusted networks do not. Instead, access from untrusted networks may be achieved via an evolved packet data gateway (ePDG) with a logical connection to a PCRF. The ePDG generally provides for IPsec security associations to the user equipment over the untrusted IP access network. The ePDG (in turn) supports mobility, policy, and AAA interfaces to the EPC, similar to the trusted IP access networks.

The MME is the primary control element for the EPC. Among other things, the MME provides tracking area list management, idle mode user equipment tracking, bearer activation and deactivation, SGW and PGW selection for user equipment, authentication services, and handover decisions. The SGW is a data plane element that can manage user mobility and interfaces with radio access networks. The SGW also can maintain the data paths between eNodeBs and the PGW, and serves as a mobility anchor when user equipment moves across areas served by different eNodeBs. The PGW provides connectivity for user equipment to external packet data networks and serves as a mobility anchor when user equipment moves across areas served by different SGWs. The PGW also detects service flows and enforces charging policies. A PCRF can be used to provide those policies to the PGW.

A PCRF is a network element responsible for coordinating charging and/or policy decisions for user equipment, such as may be associated with policy services, as illustrated in FIG. 1. A PCRF can be configured to use subscription information as a basis for the policy and charging control decisions. The subscription information may apply for both session-based and non-session based services. A PCRF can maintain session linking via policy interactions with a PGW (and possibly an SGW) and application functions (e.g., provided as part of the operator's IP services). An application function (AF) can be provided within a PCRF (or simply interact with a PCRF) in order to offer applications that require dynamic policy and/or charging control. The AF can communicate with a PCRF to transfer dynamic session information. Additionally, any type of policy and/or charging control element (e.g., PCC infrastructure) can be provided within (or suitably interact with) a PCRF.

A 3GPP EPS architecture may further provide a series of interfaces, which can offer mobility, policy control, AAA functions, and charging activities for various network elements. For example, interfaces can be used to exchange point of attachment, location, and access data for user equipment. Resource, accounting, location, access network information, network address translation (NAT) control, etc. can be exchanged using a remote authentication dial in user service (RADIUS) protocol or any other suitable protocol where appropriate. Other protocols to be used in such communications can include Diameter, service gateway interface (SGI), terminal access controller access-control system (TACACS), TACACS+, etc.

In operation, user equipment can attach to an access network for purposes of establishing a communication session. The user equipment can communicate with an eNodeB, which can further interact with an MME to complete some form of authentication for a particular user or user equipment. The MME can interact with an SGW, which interacts with a PGW such that a session is established between these components. Tunnels could be established at this juncture, and a suitable IP address could also be issued for this particular user equipment. This process generally involves a default EPS bearer being created for the user equipment. As the session is established, the PGW can interact with a PCRF to identify policies associated with the particular user or user equipment, such as a certain QoS setting, bandwidth parameter, latency setting, priority, billing, etc.

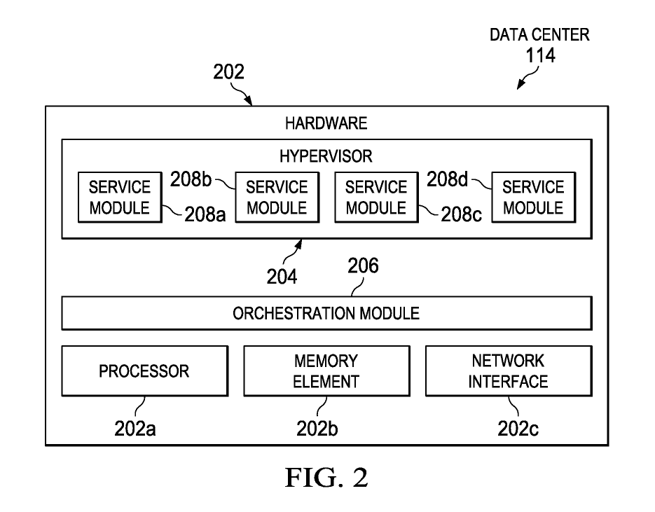

Turning to FIG. 2, FIG. 2 is a simplified block diagram illustrating additional details that may be associated with an example embodiment of data center 114. In general, data center 114 may be a virtualized environment that obscures hardware characteristics from services and applications. In some embodiments, data center 114 may be part of a distributed data center system, and may itself be a virtualized component of a cloud-based data center. In this example embodiment data center 114 generally includes a hardware element 202, and a hypervisor 204. In general, hardware 202 represents any machine or apparatus that is capable of accepting, performing logic operations on, storing, or displaying data, and may include without limitation a processor element 202a, a memory element 202b, and a network interface 202c. Moreover, data center 114 may include additional hardware and/or software elements, such as an orchestration module 206, and a plurality of service modules 208a-208d. Hence, appropriate software and/or hardware may be provisioned in data center 114 to facilitate the activities discussed herein.

Orchestration module 206 may be generally associated with providing orchestration services 114e. In some embodiments, service modules 208a-208d may be generally associated with providing identity services 114a, policy services 114b, location services 114c, and security services 114d, for example. In other embodiments, resources such as switches, routers, processors, memory, and/or interfaces may be abstracted on a network element, and service modules may be representative of other services, such as deep packet inspection, network address translation, anchor, gateway, etc. Thus, hypervisor 204 can provide a simulated computing environment, often referred to as a “virtual machine,” for services, but may also additionally or alternatively provide a simulated network environment for such services.

In regards to the internal structure associated with elements of communication system 100, each of access gateways 104a-104b, anchor gateway 110, data center 114, and other elements can include memory elements (or virtual memory elements) for storing information to be used in the operations outlined herein. Each of access gateways 104a-104b, anchor gateway 110, data center 114, and other components may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, or in any other suitable component, device, element, or object where appropriate and based on particular needs. Any of the memory elements discussed herein should be construed as being encompassed within the broad term “memory element” or “memory.” Information being used, tracked, sent, or received by access gateways 104a-104b, anchor gateway 110, data center 114, and other elements could be provided in any database, register, queue, table, cache, control list, or other storage structure, all of which can be referenced at any suitable timeframe. Any such storage options may be included within the broad term “memory element” or “memory” as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory media. In some of these instances, memory elements can store data used for the operations described herein. This includes the memory elements being able to store software, logic, code, or processor instructions that are executed to carry out the activities described herein.

In one example implementation, access gateways 104a-104b, anchor gateway 110, data center 114, and other elements may include software modules (e.g., orchestration module 206 and/or service modules 208) to achieve, or to foster, operations as outlined herein. In other embodiments, such operations may be carried out by hardware, implemented externally to these elements, or included in some other network device to achieve the intended functionality. Alternatively, these elements may include software (or reciprocating software) that can coordinate in order to achieve the operations, as outlined herein. In still other embodiments, one or all of these devices may include any suitable algorithms, hardware, software, components, modules, interfaces, or objects that facilitate the operations thereof.

Additionally, each of access gateways 104a-104b, anchor gateway 110, data center 114, core and access transport network routers, and/or other elements may include one or more processors (or virtual processors) that can execute software or an algorithm to perform activities as discussed herein. A processor or virtual processor can execute any type of instructions associated with the data to achieve the operations detailed herein. In one example, a processor (such as shown in FIG. 2) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term “processor.”

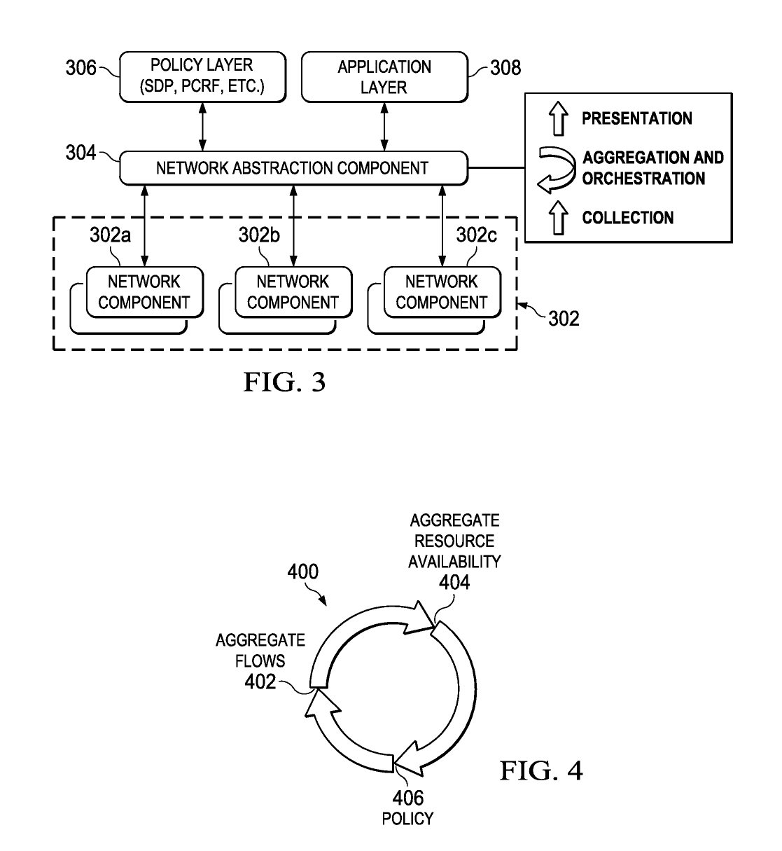

FIG. 3 is a simplified block diagram illustrating a hierarchical perspective of an example embodiment of communication system 100. An execution layer 302 is at the bottom of the hierarchy and it contains a plurality of network elements 302a-302c such as routers, gateways, switches, radio interfaces, etc. Each network element 302a-302c can represent a finite set of resources and capabilities. A network abstraction component 304 may be provided above execution layer 302. Network abstraction component 304 can collect and aggregate resource availability from execution layer 302, and provide abstract visibility into the aggregate resource availability. For example, network abstraction component 304 may receive feedback from network components 302a-302c through various interfaces, such as a simple network management protocol (SNMP), an extensible markup language (XML) interface, an extensible messaging and presence protocol (XMPP), or a 3GPP interface, for example an X2 interface that exposes radio resource availability in an LTE architecture.

Network abstraction component 304 may further receive policy requests from a policy layer 306 and/or an application layer 308. In general, a policy defines network, application, and subscriber conditions that must be met to successfully deliver a service or maintain its QoS. A policy request includes any signal, message, or other type of communication to allocate, schedule, define, identify, or otherwise request resources for implementing or enforcing a policy. Policy layer 306 may, for example, include a PCRF, service delivery platform (SDP), etc. that requests a guaranteed QoS for a video stream. Based on the aggregated resource availability, network abstraction component 304 can determine if resources are available for the requested policy function.

If the resources are available, network abstraction component 304 can respond accordingly and orchestrate the resources needed to satisfy the policy request. Orchestrating resources broadly includes activities such as scheduling requests for resources from various systems, determining conflicts, prioritizing requests, and/or determining resource availability based on analytics and polling. If the resources are not available, network abstraction component 304 can deny the request. Thus, for example, if resources are available for providing a guaranteed QoS for a video stream, network abstraction component 304 may set certain parameters (e.g., QoS class identifier) on a radio, set a DSCP value to be used in the backhaul transport core, cache traffic at a particular location, provide video optimization, etc.

In another aspect, it may be determined that a resource or group of resources is being consumed from multiple endpoints and network abstraction component 304 can orchestrate resources to optimize traffic. For example, policy layer 306 or application layer 308 may determine that a group of subscribers is accessing common content (e.g., such as streaming video) through different gateways. Communication system 100 may include a policy for consolidating or otherwise relocating the subscribers under such conditions. If policy layer 306 or application layer 308 requests consolidation, network abstraction component 304 can evaluate resource availability and consolidate the subscribers to a single gateway, for example. Evaluating resource availability may include determining if a single gateway can provide resources for multicasting to the group of subscribers and determining the impact to other network elements or flows. Based on resource availability, network abstraction component 304 may orchestrate the consolidation of subscribers (e.g., using an explicit detach with re-attach required) and establishing a multicast tree to optimize the traffic flow.

In yet another aspect, analytic information can be leveraged to understand how particular IP flows may be impacting aggregate resource availability, and network abstraction component 304 can relocate resources to optimize the IP flows based on policy. For example, gateways can be virtualized and relocated in a cloud-based system to optimize other aspects of aggregate resource availability, such as offloading core links or localizing traffic.

FIG. 4 is a simplified flow diagram illustrating the integration of policy and orchestration services in a unified management domain that may be associated with example embodiments of communication system 100. In this example, policy and orchestration are integrated with IP flows in a closed loop 400. More particularly, an understanding of aggregate IP flows at 402 can be fed into an orchestration service that provides aggregate resource availability at 404, and the aggregate resource availability may be fed into a policy service at 406. Closing the loop, the policy decision can be used to modify the IP flow at 402. Policy and orchestrations services may be implemented on the same platform in some implementations, while in others an external interface may be deployed between a policy server on one platform and an orchestration system on another, for example.

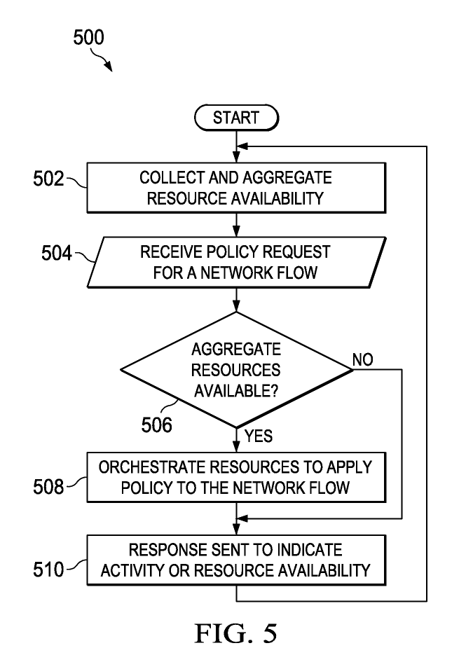

FIG. 5 is a simplified flow diagram 500 illustrating potential operations that may be associated with example embodiments of communication system 100. In more particular embodiments, such operations may be implemented in orchestration module 206 and/or service module 208, for example. At 502, resource availability may be collected from network elements and subsequently aggregated. At 504, a request to apply a policy to a network flow may be received. For example, orchestration module 206 may receive a request from a PCRF to modify an IP flow to deliver a guaranteed QoS for a subscriber. The PCRF may be integral to such a module or may communicate with the module through an external interface. If aggregate resources from the network elements are available at 506, the resources may be orchestrated to apply the policy to the network flow at 508. A suitable response can be sent at 510 to indicate this policy application. If aggregate resources are not available at 506, a response may be sent at 510 that denies the request, or that provides notification that resources are unavailable. Orchestrating the resources may include configuring resources to provide a guaranteed QoS, modifying the network flow (or other network flows), relocating (e.g., “rehoming”) subscribers, and/or relocating virtual resources, for example.

As described herein, communication system 100 can provide many significant advantages, some of which have already been discussed. For example, communication system 100 may link IP flow awareness, aggregate resource availability, and policy decisions to optimize the system. Per-subscriber IP flow-level decision are possible, such as increasing compression/optimization, canceling DPI for flows, or re-homing subscribers, based on aggregate resource availability, such as IP edge capacity at a specific node, DPI availability at a specific node, data center resources, or cache space, for example. Moreover, communication system 100 can provide a service management framework integrating network services, end-user applications, data center resources, and network processes into an orchestrated delivery system to reduce both development time for new use cases and costs associated with continued manual provisioning of information technology services, data center resources, and network capabilities.

In the examples provided above, as well as numerous other potential examples, interaction may be described in terms of two, three, or four network elements. However, the number of network elements has been limited for purposes of clarity and example only. In certain cases, it may be easier to describe one or more of the functionalities of a given set of operations by only referencing a limited number of network elements. It should be appreciated that communication system 100 is readily scalable and can accommodate a large number of components, as well as more complicated/sophisticated arrangements and configurations. Accordingly, the examples provided should not limit the scope or inhibit the broad teachings of communication system 100 as potentially applied to a myriad of other architectures. Additionally, although described with reference to particular scenarios, where a particular module, such as orchestration module 206, is provided within a network element, these modules can be provided externally, or consolidated and/or combined in any suitable fashion. In certain instances, such modules may be provided in a single proprietary unit.

It is also important to note that the appended diagrams illustrate only some of the possible scenarios and patterns that may be executed by, or within, communication system 100. For example, some operations may be deleted or removed where appropriate, or these operations may be modified or changed considerably without departing from the scope of teachings provided herein. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 100 in that any suitable arrangements, chronologies, configurations, and timing mechanisms may be provided without departing from the teachings provided herein.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
aggregating resource availability from a plurality of network elements operating in a network;
receiving a request to apply a policy to a network flow propagating in the network; and
orchestrating resources to apply the policy to the network flow based on the aggregated resource availability.

2. The method of claim 1, wherein the policy comprises a quality of service for the network flow.

3. The method of claim 1, wherein the policy comprises relocating subscribers accessing common content from a first gateway to a second gateway.

4. The method of claim 1, wherein the policy comprises relocating resources for the network flow.

5. The method of claim 1, wherein aggregating resource availability comprises receiving feedback from the plurality of network elements.

6. The method of claim 1, further comprising:
receiving analytics information indicating that assigned network resources are no longer available for a particular flow.

7. The method of claim 1, wherein the request is received from a policy and charging rules function, and wherein orchestrating resources comprises designating a path for the network flow.

8. The method of claim 1, further comprising:
determining additional resources are unavailable for a particular network flow propagating in the network; and
communicating a response to a particular one of the network elements to indicate that the additional resources are unavailable.

9. Logic encoded in one or more non-transitory media that includes code for execution and when executed by one or more processors is operable to perform operations comprising:
aggregating resource availability from a plurality of network elements operating in a network;
receiving a request to apply a policy to a network flow propagating in the network; and
orchestrating resources to apply the policy to the network flow based on the aggregated resource availability.

10. The logic of claim 9, wherein the policy comprises relocating subscribers accessing common content from a first gateway to a second gateway.

11. The logic of claim 9, wherein the policy comprises relocating resources for the network flow.

12. The logic of claim 9, wherein aggregating resource availability comprises receiving feedback from the plurality of network elements.

13. The logic of claim 9, the operations further comprising:
receiving analytics information indicating that assigned network resources are no longer available for a particular flow.

14. The logic of claim 9, wherein the request is received from a policy and charging rules function, and wherein orchestrating resources comprises optimizing a path for the network flow.

15. An apparatus, comprising:
a memory element; and
a processor coupled to the memory element, wherein the processor is configured to execute instructions associated with an orchestration module and a policy module such that the apparatus is configured for:
aggregating resource availability from a plurality of network elements operating in a network;
receiving a request to apply a policy to a network flow propagating in the network; and
orchestrating resources to apply the policy to the network flow based on the aggregated resource availability.

16. The apparatus of claim 15, the operations further comprising:
receiving analytics information indicating that assigned network resources are no longer available for a particular flow.

17. The apparatus of claim 15, wherein the policy comprises relocating subscribers accessing common content from a first gateway to a second gateway.

18. The apparatus of claim 15, wherein the policy comprises relocating resources for the network flow.

19. The apparatus of claim 15, wherein aggregating resource availability comprises receiving feedback from the plurality of network elements.

20. The apparatus of claim 15, wherein the apparatus is further configured for:
determining additional resources are unavailable for a particular network flow propagating in the network; and
communicating a response to a particular one of the network elements to indicate that the additional resources are unavailable.
